(19) United States
(12) Patent Application Publication
(10) Pub. No.: US 2018/0133800 A1
(43) Pub. Date: May 17, 2018

(54) CONSTRUCTION CYLINDER ARRANGEMENT FOR A MACHINE FOR PRODUCING THREE-DIMENSIONAL OBJECTS IN LAYERS

(71) Applicant: TRUMPF Laser- und Systemtechnik GmbH, Ditzingen (DE)

(72) Inventors: Markus Pieger, Stuttgart (DE); Stefan Weber, Besigheim (DE)

(21) Appl. No.: 15/849,937

(22) Filed: Dec. 21, 2017

Related U.S. Application Data
(63) Continuation of application No. PCT/EP2016/064485, filed on Jun. 23, 2016.

(30) Foreign Application Priority Data
Jun. 23, 2015 (DE) 102015211538.0

(51) Int. Cl. B22F 3/105; B29C 64/245; B29C 64/205; B29C 64/153

(52) U.S. Cl. CPC B22F 3/1055; B29C 64/245; B28B 1/001; B29C 64/153; B29C 64/205

(57) ABSTRACT

This disclosure features construction cylinder arrangements for machines for producing three-dimensional (3D) objects in layers by laser sintering or laser melting powdered material. These arrangements include a base member and a piston that can be displaced along a central axis of the base member at an inner side of the base member, wherein the piston has at the upper side thereof a substrate for growing the 3D objects and wherein the base member includes an insulation member that forms at least the inner side of the base member, wherein the insulation member includes a material having a specific thermal conductivity λIK, with λIK≤3W/(m*K). The piston can be constructed with an upper piston portion and a lower piston portion, wherein the upper portion includes the substrate and the lower portion includes a cooling device. The construction cylinder arrangements have improved gas-tight sealing even at high temperatures, for example, above 500° C.

### CROSS-REFERENCE TO RELATED APPLICATIONS

This application is a continuation of and claims priority under 35 U.S.C. § 120 from PCT Application No. PCT/EP2016/064485 filed on Jun. 23, 2016, which claims priority from German Application No. DE 10 2015 211 538.0, filed on Jun. 23, 2015. The entire contents of each of these priority applications are incorporated herein by reference.

### TECHNICAL FIELD

The invention relates to a construction cylinder arrangement for machines for producing three-dimensional objects in layers by laser sintering or laser melting powdered material.

### BACKGROUND

Construction cylinder arrangements are described in EP 2732890 A2. By producing three-dimensional objects in layers by means of laser sintering or laser melting (also referred to as “selective laser sintering” or “selective laser melting”), there can be produced object geometries that are not accessible with conventional techniques (which are based, for example, on a casting process or milling a solid body).

In this case, a thin layer of a powdered material is applied to a substrate (also referred to as a construction platform) in a construction cylinder (also referred to as a construction chamber) and then heated with a processing laser beam at selected locations until the powdered material melts or sinters. Subsequently, the substrate is lowered by a layer thickness of the powder in the construction cylinder, an additional layer of the powdered material is applied, and again heated by the processing laser beam at selected locations, and so on. The application and the heating of the powdered material are generally carried out with air being excluded to prevent oxidation processes, particularly if a powdered metal material is being processed.

A machine for such production of three-dimensional objects in layers is described in EP 2732890 A2, which illustrates a storage chamber for powdered material, a construction chamber, and a collection container arranged on a process chamber. The powdered material can be swept with a slide from the storage chamber to the construction chamber and (in the case of an excess of powder) into the collection container. The construction chamber comprises an annular base member, in which a construction platform, which is fixed to a retention structure, moves. The retention structure is sealed with respect to the base member. To adapt the size of the construction chamber, the annular base member on the machine can be exchanged.

To prevent mechanical stresses in the finished component, it is advantageous to preheat the powdered material before the action of the processing laser beam. However, an unintentional heating of other components of the machine may impair the production quality or even damage the machine.

WO 2011/082812 A1 describes a machine for generatively producing a three-dimensional object, wherein a construction cylinder in which a carrier can be displaced with a lifting device is retained with thermal insulation in a plate. A freshly applied powder layer can be preheated with a heating device above the carrier before a laser sintering takes place.

It is proposed in US 2013/0004680 A1 to provide a bridge-like device, which produces thermal insulation between an object and a base block, between the object which is deposited in layers and the base block on a displaceable retention member.

EP 1347853 B1 discloses an apparatus for producing three-dimensional objects in layers by means of laser melting, wherein a work chamber is arranged in an air-tight chamber. The work chamber is provided with a construction cylinder. A piston in the construction cylinder is sealed with respect to the construction cylinder with metal piston rings. Heating components are provided above and below a target surface.

When the powdered material is heated in an applied layer for preparing the laser processing, the substrate and the piston, and generally also the base member of the construction cylinder arrangement, are also substantially heated. When powdered material is used with high melting or sintering temperatures, as with most metals and ceramic materials, this makes it considerably more difficult to seal in a gas-tight manner between the piston and the base member.

The metal piston rings proposed in EP 1347853 B1 can also be used at high temperatures (for example, above 500° C.), but have to be produced in a very precise manner. Temperature gradients can easily result in a distortion of the piston or the piston rings or the base member, which distortion cannot be rectified practically, which may cause leaks or even jamming of the piston. The metal piston rings require a base member which is also made of metal and which has similar thermal expansion behavior as the piston rings, whereby the base member becomes very hot during operation.

### SUMMARY

The object of the invention is to provide a construction cylinder arrangement with which an improved gas-tight sealing can be achieved between the piston and the base member at high temperatures (for example, above 500° C.).

In one aspect, the disclosure relates to construction cylinder arrangements that include a base member that includes a substantially cylinder-jacket-like insulation member that forms at least the inner side of the base member, wherein the insulation member is or includes a material having a specific thermal conductivity λIK, wherein λIK≤3 W/(m*K), a piston constructed with an upper portion and a lower portion, wherein the upper portion forms a substrate and wherein the lower portion has a cooling device, for example, a cooling water channel system, and a first seal of elastomeric material provided on the lower portion with which the lower portion of the piston is sealed in a gas-tight manner with respect to the inner side of the base member.

According to some embodiments of the invention, the construction cylinder arrangement can be constructed in such a manner that it can be sealed with a seal of elastomeric material even if high temperatures (for example, 500° C. or more, e.g., between 600° C. and 1000° C.) are produced in the region of the substrate to heat the powdered material.

Furthermore, in some embodiments, the piston can be constructed in several pieces. In an upper portion of the piston, which includes the substrate, a high temperature is allowed (usually 500° C. or more in the region of the substrate) to heat a layer of the powdered material before laser processing. Typically, this high temperature at the substrate is produced with a heating device in the piston; however, for example, a radiant heater can also be provided above the substrate. In a lower portion of the piston, a lower temperature is produced by a cooling device (typically 45° C. or less, e.g., 30° C. or less). There is also fixed to this lower portion the first seal, which is cooled by the cooling device via the lower portion. Therefore, there is in the piston a temperature gradient between the upper portion (in particular the substrate) and the lower portion. Typically, the production of this temperature gradient is supported by ceramic insulation components (for example, ceramic rings or ceramic discs) in the piston between the upper portion and the lower portion.

On the other hand, in some embodiments, the base member of the construction chamber arrangement can be constructed at least at an inner side thereof with an insulation member of a material with a lower thermal conductivity, e.g., λIK≤3 W/(m*K). The base member is subjected to an introduction of heat at the inner side thereof in the region of the upper portion of the piston, in particular in the region of the substrate, and where applicable also from a region located above where the three-dimensional object is already partially produced, in a first axial portion. However, the first seal is arranged at the lower portion of the piston and is subjected to an introduction of heat from the base member in a second axial portion.

However, this second axial portion is located axially under and with corresponding axial spacing from the first axial portion. In practice, structures of the upper portion that are radially nearest to the insulation member or that touch the insulation member and portions of the first seal, which abut the insulation member, are typically at least 5 cm and often at least 7 cm axially away from each other. Since the thermal conductivity of the base member at the inner side thereof is very low as a result of the material of the insulation member, however, the heat influx from the base member in the first axial portion into the first seal is small and can be compensated for by the cooling device to an extremely great extent so that the material of the first seal is exposed only to a moderate temperature (typically a maximum of 200° C., e.g., a maximum of 150° C.). At a moderate temperature, the first seal can be produced from an elastomeric material without anticipating damage to the first seal as a result of the active temperature; in particular, no metal seals are necessary.

A very good gas-tightness over a great tolerance range can be produced with the first seal of elastomeric material for a local gap width, which is intended to be sealed between the base member and the piston. A particular production accuracy for the first seal or the seat thereof is unnecessary and a conventional distortion as a result of temperature gradients does not impair the sealing or can readily be compensated for by means of the resilience of the sealing material. A typical material for the first seal is silicone rubber (for temperatures up to approximately 250° C.).

Laser processing of the powdered material can reliably be ensured with the elastomer seal according to the invention with air exclusion (under a protective gas atmosphere such as N₂ or Ar or also under a vacuum); oxidation on the powdered material is prevented. In particular, a constant excess pressure of the protective gas (usually in conjunction with a constant through-flow of protective gas) in the process chamber is unnecessary.

It should be noted that the material of the insulation member preferably also has a small (linear) thermal expansion coefficient α, typically with α≤3×10⁻⁶ 1/K.

In a machine in which the construction cylinder arrangement according to the invention is fitted, the lower portion is connected to a lifting device for displacing the piston in the base member. The upper piston portion is directly or indirectly (via a central portion) supported on the lower piston portion, e.g., supported so as to be lying thereon, and typically also fixed. The piston including the substrate and excluding the first seal and where applicable additional seals and flexible contact elements is preferably constructed so as to have a substantially smaller outer diameter than the inner diameter of the insulation member so that no mutual contact occurs, neither in the cold state nor in the hot state (except for via the first seal and where applicable additional seals and flexible contact elements, including stuffing boxes or packing materials). The substrate can thereby be adjusted inside the base member with respect to the orientation thereof (tilting), e.g., the substrate can be aligned (levelled) in the case of distortion as a result of temperature gradients so as to be approximately planar.

The powdered material is typically a metal material or ceramic material with a mean particle size (D50) between 25 μm and 100 μm.

In certain embodiments of the construction cylinder arrangement according to the invention, the material of the insulation member is a ceramic material or a glass, preferably quartz glass, particularly preferably opaque quartz glass. Many ceramic materials and glasses have a poor thermal conductivity, are sufficiently temperature-stable, and are further highly resistant to thermal shocks. This particularly applies to quartz glass, in particular opaque quartz glass. Opaque (non-light-permeable) material that reflects infrared radiation well is preferably used, which reduces the heating of the insulation member as a result of heat radiation.

An embodiment is also preferred in which ceramic insulation components, in particular a ceramic insulation plate and/or a ceramic ring and/or ceramic discs, are arranged in the piston between the upper piston portion and the lower piston portion. The production of a temperature gradient between the upper piston portion and the lower piston portion can thereby be supported. Accordingly, the temperature-sensitive first seal provided on the lower piston portion made of elastomeric material can be protected particularly well.

In some embodiments, the first seal is constructed as a hydraulic or pneumatic seal, the outer diameter of which can be adjusted by a pressure of hydraulic fluid or gas. It is thereby possible to contract the first seal radially when the lower portion of the piston is withdrawn and/or introduced into/out of the base member of the construction cylinder arrangement so that it does not impair the displacement of the piston and also to reduce a danger of damage to the first seal. Vice versa, a particularly close and tight abutment against the inner side of the base member and the outer side of the piston is possible in the radially expanded state.

In other embodiments, the piston has a heating device with which the substrate can be heated, in particular to a temperature of 500° C. or more, wherein the heating device is arranged below the substrate and above the lower piston portion, which has the cooling device. The heating device is arranged between the substrate and the cooling device, whereby temperature gradients in the substrate can be kept small. At a temperature of the substrate (and therefore approximately also of the layer of powdered material thereon which is intended to be processed) of 500° C. or more, many metal and ceramic powders can be subjected to laser processing (laser melting, laser sintering) with small resultant mechanical stresses.

In advantageous developments of this embodiment, the heating device includes one or more infrared heating elements, e.g., heating coils, for an infrared absorption layer having an infrared absorption capacity of 0.8 or more to be provided above the one or more heating elements, in particular wherein the infrared absorption layer includes black chrome or titanium aluminum nitride, and for an infrared reflection layer having an infrared reflection capacity of 0.8 or more to be provided under the one or more infrared heating elements, in particular wherein the infrared reflection layer includes a reflective metal layer or a reflective ceramic layer. As a result of infrared heating elements, heat can readily be introduced into the substrate and the layer of powdered material thereon. The introduction of heat upwards in the direction of the substrate can be maximized by the infrared absorption layer and the introduction of heat downwards into the lower portion of the piston can be minimized by the infrared reflection layer.

In a further development in this regard, the infrared absorption layer can be constructed or arranged on the lower side of the substrate and the infrared reflection layer can be constructed or arranged on the upper side of a ceramic insulation plate. It is particularly easy to fit the infrared absorption layer to the lower side of the substrate. The introduction of heat into the lower portion can be reduced with the ceramic insulation plate in addition to the infrared reflection layer.

In another embodiment, a flexible contact element, e.g., a packing material made of a woven graphite fabric or graphite felt or a flexible metal spring, which abuts the inner side of the insulation member, is provided on the lower portion above the first seal. As a result of the contact element, for example, a packing material made of a woven graphite fabric or graphite felt, the inner side of the insulation member can be cooled locally by means of the cooling device via the lower piston portion to reduce the temperature of the insulation member in the contact region with respect to the first seal. Graphite has a good level of thermal conductivity with a high temperature resistance. Alternatively, packing materials made of a woven fabric or a felt of another material can also be used, wherein this other material should have a good thermal conductivity (preferably of at least half of the thermal conductivity of graphite).

Alternatively, it is further also possible to use a flexible metal spring for locally transmitting heat from the cylinder face to the cooling element of the piston. The flexible contact element is typically constructed in an annular manner so as to extend around the lower portion. As a result of the flexibility of the contact element, the contact element does not jam in the insulation member even if the piston should be inclined (slightly) with respect to the cylinder axis of the base member, for example, as a result of levelling adjustment.

Embodiments Relating to Levelling the Substrate

In other embodiments, the piston has at least two, e.g., three, positioning elements with which the upper portion can be aligned relative to the lower portion to level the substrate. According to this embodiment, the upper portion of the piston can be adjusted relative to the lower portion of the piston with respect to the orientation (tilting). The adjustment of the upper portion can be carried out from below so that the entire upper side of the substrate is available for producing the three-dimensional object(s); in particular, no screw holes or the like are necessary in the upper substrate side. The axial (vertical) position of the piston can be fixed via a simple vertical lifting device on the relatively cold, lower portion. This is, on the one hand, structurally simple and, on the other hand, particularly highly suitable for adjusting the orientation of the substrate in the hot state (for example, 500° C. or more). In the case of two positioning elements, a fixed support location (“passive support location”) is further provided; in the case of three positioning elements, the axial position of the substrate relative to the lower portion can also be adjusted (to a small extent). The positioning elements can be constructed, for example, in the manner of a piezo-actuator or an encapsulated spindle drive.

In additional embodiments, the piston can be further constructed with a central portion, wherein the upper portion is supported on the central portion, e.g., is supported so as to be lying thereon, and for the central portion to be able to be aligned relative to the lower portion by means of the positioning elements. As a result of the central portion, a readily maneuverable construction can be brought about, in particular it is more easily possible to divide the piston in the event of a change of the construction cylinder arrangement in the machine. The central portion typically comprises the heating device, where applicable the ceramic insulation plate, and a metal base plate. The lower portion typically includes a base, on which the lifting device engages, and a cooling plate, in which the cooling device is constructed.

In other embodiments, the positioning elements each have an expansion element, whose length is variable as a result of the temperature, and an electrical heating element, with which the expansion element can be heated so that a local spacing of the upper portion relative to the lower portion or central portion at the respective positioning element can be adjusted by adjusting the temperature of the expansion element via the electrical heating element and by impact of the cooling device. For example, the expansion element can include a metal piece made of a shape memory alloy or a glycerine expansion element. In addition, a very fine adjustment of the local spacing between the lower portion and the upper portion or central portion is possible by means of expansion elements with an electrical heating element, and consequently a very precise levelling of the substrate. The heating current can be controlled in a very fine manner and no perceptible mechanical hystereses occur. The expansion element can be arranged, for example, between two ceramic discs or be connected to the lower portion and the upper portion or central portion via ceramic discs. Expansion material elements having a fluid expansion medium, for example, a glycerine expansion element, can achieve particularly high length expansions per change in temperature and can provide comparatively great positioning forces as a result of the incompressibility of the fluid contained.

In alternative embodiments, the positioning elements each comprise a differential screw that is guided with a first thread portion of a first pitch in a counter-thread in the upper portion or in a central portion of the piston and with a second thread portion of a second pitch in a counter-thread in the lower portion of the piston, for example, wherein the differential screw can be adjusted with an electric motor. It is readily possible to convert a rotational movement into a change in spacing along the rotation axis by means of a differential screw, in accordance with the difference of the first and second pitch. The rotational movement can be readily motorized and automated.

Embodiments for a Divisible Piston and for Removing the Base Member

In some embodiments, the upper piston portion is releasably supported on the remaining piston, in particular so as to be lying thereon. In the event of a change of the construction cylinder arrangement in the machine, the upper portion (including the substrate and typically a second seal) can thereby remain in the base member of the construction cylinder, in particular to seal it at least provisionally against the ambient air, whereas the remaining, e.g., lower, portion remains on the machine and is supplemented by a new upper portion and a new base member. After a three-dimensional object (workpiece) has been completed, the machine can thereby can be quickly made ready for producing an additional three-dimensional object. The base member becomes only slightly warm at the outer side during the production of the object as a result of the internal insulation member. In the case of a support lying thereon, the remaining portion of the piston can be readily removed from the upper portion if the upper portion is fixed or retained in the base member, for example, with a locking bar system.

In developments of this embodiment, the piston has a central portion that can be aligned relative to the lower portion by means of positioning elements, wherein the upper piston portion is supported in a rotationally secure manner on the central portion of the piston so as to be lying thereon, wherein the upper portion can be axially clamped by means of a rotationally actuated clamping device on the central portion. The upper portion can be optionally released from the central portion by means of the clamping device to be able to lift the upper portion off the central portion, or for the upper portion to be clamped to the central portion to control the axial position and orientation of the upper portion for producing the object. The rotational movement of the clamping device is not transmitted to the substrate as a result of the rotationally secure support, for example, by means of a locking pin. The rotational actuation can be produced favorably in practice, for example, by means of a mechanism that acts from below (and which is constructed on the lower portion and/or central portion).

In further developments of this embodiment, the clamping device comprises a locking bar and a retention member, for the locking bar to be rotatably supported in the central portion of the piston, wherein in a first rotational position the locking bar can be introduced into and withdrawn out of the retention member at the lower side of the substrate, and wherein the locking bar engages behind the retention member in a second rotational position.

In other embodiments, one or more inclined faces are constructed on the locking bar and/or the retention member so that, by rotating the locking bar in the retention member from the first position into the second position, the substrate is pressed downwards relative to the locking bar. In the first rotational position, the locking bar can be guided out of the retention member by lifting the upper portion off the central portion and can be introduced into the retention member by placing the upper portion on the central portion. In the first rotational position, consequently, the piston can be divided: in this case, the usually still-hot upper portion typically remains in the construction chamber base member and substantially seals the interior of the cylindrical base member in a downward direction; the base member with the upper portion of the piston is then typically removed from the machine. The central portion and the lower portion of the piston remain in the machine; after a new base member with a new upper portion and a substrate that is still non-coated have been positioned, the machine can rapidly be made ready for operation once more.

In the second rotational position, the upper portion is clamped to the central portion by the locking bar, which is screwed into the retention member, and the alignment of the central portion relative to the lower portion by means of the positioning elements also brings about an alignment of the upper portion including the substrate relative to the remaining machine. It is readily and reliably possible via the locking bar mechanism to bring about the connection and disconnection of the upper portion relative to the remaining piston. The locking bar can be constructed, for example, approximately in a hammer-like shape (with a projecting locking bar head at the upper end of a shaft).

In this case, there is advantageously provided a guide element fixed to the locking bar, wherein the guide element is supported or suspended on the central piston portion or the lower piston portion via a resilient element, and wherein the resilient element pretensions the locking bar via the guide element into a position that is drawn axially downwards. In the second rotational position of the locking bar, a minimum retention force can be produced via the resilient element for the upper portion, with which it is drawn towards the central portion. In this case, the locking bar is supported in the central portion in an axially displaceable manner. A rotary stop for the locking bar can be produced to define the second rotational position. The resilient element is preferably a pressure spring, which can be arranged between the guide element and the central portion. The guide element can be constructed as a straight-toothed spur gear that engages in a gear mechanism of the lower portion to actuate the locking bar, wherein an axial offset of the guide element relative to the lower portion as a result of a rotational movement of the locking bar does not move the guide element out of engagement with the gear mechanism.

In a further development, the clamping device comprises a cylindrical or conical first threaded element, e.g., supported on the central portion, and a conical second threaded element, e.g., constructed on the lower side of the substrate, wherein the threaded elements can be screwed together to clamp the central portion and the upper portion. It is readily possible to clamp by means of the at least one conical threaded element, wherein the screwing path is inherently limited, which is used to define a clamped position.

In another embodiment, a second seal is constructed on the upper portion to seal the upper portion of the piston relative to the inner side of the base member at least in a sealing manner for the powdered material. The powdered material is thereby kept remote from the first seal so that the sealing effect of the first seal is not impaired by powder particles. Furthermore, the second seal can achieve, in the event of a separation of the piston between the upper portion and lower portion for the purpose of a rapid exchange of the still-hot base member with the upper portion of the piston (and finished three-dimensional object) for a new base member with a new upper portion of the piston (and as yet no three-dimensional object), a provisional sealing of the interior of the still-hot base member to minimize oxidation processes on the finished three-dimensional object contained therein.

In another development of this embodiment, the second seal is constructed as a metal fiber seal made of metal fibers that are pressed together, wherein the pressed metal fibers are arranged between the piston and the inner side of the base member with resilient compressive strain, e.g., wherein the metal fibers that are pressed together are constructed as a peripherally closed knitted stocking fabric. The metal fiber seal is resiliently dimensionally flexible as a result of the resilient bending of the contained metal fibers (metal wires) to a given extent, whereby a play between the outer side of the piston and the inner side of the base member can be compensated for, for example, in the case of different thermal expansion of the piston and the base member or in the case of mutual tilting during (planar) adjustment of the substrate. The metal fibers are scarcely subjected to fiber breakages, which prevents contamination of the powdered material. The metal material of the metal fibers further allows oxidation processes at the second seal to be prevented if it is exposed in the hot state (substantially at the temperature of use ET) to oxygen in the air at the outer side, for example, in the case of exchange of the base member together with the upper portion of the piston.

The wire material is preferably selected so that the modulus of elasticity only slightly decreases in the event of heating to the temperature of use ET, preferably less than 20% with respect to ambient temperature over (at least) 100 hours, at 500° C.≤ET≤1000° C. The yield strength (Rp, 0.2) should also decrease only slightly in the event of heating to the temperature of use ET, preferably less than 30% with respect to ambient temperature over (at least) 100 hours. Nickel-based alloys such as Inconel 718® or Inconel X-750® or Nimonic 90® are particularly preferred as wire materials that can also comply with the above properties. The metal fibers are typically constructed so as to have a diameter between 0.1 mm and 0.4 mm, usually between 0.2 mm and 0.25 mm. A typical density of the pressed metal fibers is between 30% and 60%, usually approximately 40%. At these values, a good resilient behavior was produced. The metal fiber seal is typically tight for powder particles having a diameter between 25 μm and 100 μm but not gas-tight. For producing the metal fiber seal, metal fibers are previously inserted into a pressing tool (preferably wherein the fibers are already interlaced with each other, for instance, as a woven fabric or knitted fabric) and pressed together in the cold state, wherein plastic deformation of the metal fibers is produced so that a uniformly maneuverable sealing member is produced. During removal from the pressing tool, the seal springs back slightly. During assembly on the construction cylinder, the metal fiber seal is resiliently compressed again (at least radially). As a result of loops, which are formed during knitting, a particularly good cohesion of the metal fibers is achieved and the metal fiber seal has only a few fiber ends.

In developments of these embodiments, the upper portion further includes a clamping ring and the second seal is produced from felt or woven material, e.g., ceramic felt or woven material, wherein the second seal seals the upper portion of the piston relative to the inner side of the base member at least in a sealed manner for the powdered material, and wherein the clamping ring and the substrate are securely connected to each other, e.g., with a press-fit, and the second seal is clamped between the substrate and the clamping ring. The second seal prevents the powdered material from being introduced into the region of the lower portion of the piston. In addition, the second seal can bring about a provisional (but generally incomplete) seal between the base member and the substrate with respect to the ambient air, for example, when the base member and substrate are changed on the machine. The second seal is formed from poorly thermally conductive material, for example, Al₂O₃ fibers or Al₂O₃ felt. The second seal can be reliably fixed by means of the clamping ring in a simple manner.

In other embodiments, in which the upper portion is releasably supported on the remaining piston, a radially extensible and retractable locking bar system is constructed on the base member, with which the upper portion of the piston can be engaged under in a displacement position of the piston at the lower end of the base member so that, when the upper portion is released from the remaining piston, the upper portion is retained in the base member. The locking bar system makes it easier to separate the piston when changing the base member and the substrate in the machine. The upper portion is prevented from falling out of the base member and the remaining portion of the piston can be readily pulled off downwards when the upper portion is engaged under. The locking bar system typically engages between the upper portion and the central portion of the piston, in particular under a clamping ring. Typically, the locking bar system is constructed so as to have inwardly pivotable locking bar webs or locking bar bolts, which can be radially extended and retracted.

In other embodiments, the base member comprises a substantially cylinder-jacket-like outer member, e.g., produced from metal, the insulation member is clamped in the outer member by means of at least one stuffing box, in particular of ceramic woven fabric or felt, and a thermal insulation structure, e.g., produced from ceramic material, is arranged at least over a portion of the axial extent of the base member between the outer member and the insulation member. In this structural type, heating of the outer side of the base member is minimized, which makes it easier and faster to change the base member and substrate after the production of an object has been concluded.

Machines for Measuring Substrate Alignment

The scope of the present invention also includes machines for producing three-dimensional objects in layers by laser sintering or laser melting powdered material, including a process chamber, to which a storage cylinder arrangement for the powdered material and a construction cylinder arrangement for a substrate for growing the three-dimensional objects are connected and in which a slide for applying a layer of the powdered material from the storage cylinder arrangement to a substrate of the construction cylinder arrangement is arranged; a processing laser for producing a processing laser beam or a coupling device for a processing laser beam; and an optical scanner unit for scanning the processing laser beam over the substrate; wherein the construction cylinder arrangement is constructed as described herein according to the invention. These machines allow a high level of processing quality, in particular also with a heated substrate of 500° C. or more, wherein a good air exclusion in the process chamber can readily be produced. The machine preferably has separate accesses for the process chamber on the one hand, and the construction cylinder arrangement on the other hand, to be able to exchange the construction cylinder without opening the process chamber. The process chamber is typically under a protective gas atmosphere, such as N₂ or Ar. A collection container for excess powdered material is usually also connected to the process chamber.

In some embodiments of the machine according to the invention, there is provided a measuring device, in particular an optical measuring device, with which the alignment of the substrate relative to the machine can be established. A need for adjustment of the alignment (in particular orientation, tilting position) of the substrate can thereby be identified and a corresponding adjustment via suitable positioning elements can be carried out, preferably automatically. The substrate is preferably measured in the hot state of the substrate, where necessary also repeatedly during the production of the three-dimensional objects. A contactless optical measurement is particularly highly suitable therefor. A triangulation measurement at least at two, e.g., three, positions of the substrate edge is particularly suitable.

In advantageous developments of this embodiment, the measuring devices comprise at least two, e.g., three, laser diodes that each project a laser line at different positions onto a gap between a reference surface, e.g., a bottom, of the process chamber and the substrate, wherein the laser line is projected at an acute angle, e.g., at an angle between 15° and 60°, relative to the reference surface of the process chamber.

In addition, the measuring devices can comprise a camera system with which a line offset in the respective laser lines can be detected. With triangulation measurement, it is readily possible to determine the tilting of the substrate relative to the reference surface (for example, the bottom) of the process chamber. The respective laser line is preferably aligned approximately perpendicularly to the local gap course in order to maximize the line offset. The positioning elements can be adjusted via an automatic control device so that the line offset is minimized in all the laser lines (or the difference with respect to a predetermined desired value is minimized), whereby a levelling of the substrate can be achieved.

In an advantageous further development in this regard, the camera system comprises a camera whose beam path is directed through the optical scanner unit so that the different positions on the gap can be detected individually with this camera by switching a scanning position of the optical scanner unit. In this case, all the line offsets can be detected with one camera without additional components with a high level of precision. The optical scanner unit (also referred to as a laser scanner) is not only used by the processing laser beam, but is also integrated in the positional establishment of the substrate and consequently used twice in an efficient manner.

In other embodiments, a laser line projected by a laser diode is provided for each positioning element, wherein the positioning element and the associated laser line are arranged approximately at the same angular positions of the substrate. The control of the levelling of the substrate is thereby made easier; each positioning element can be adjusted by means of the associated laser line or the line offset at that location substantially independently of the other line offset(s).

Associated Operating Methods

The scope of the present invention also includes methods for operating any of the machines described herein according to the invention, in which at least the layer of the powdered material is heated to a temperature of at least 500° C. during and/or after an application of a layer of the powdered material to the substrate and/or the partially produced three-dimensional object, and the processing laser beam processes the heated layer with air being excluded, and wherein during a plurality of cycles of lowering the piston in the base member by a layer thickness, applying a layer of powdered material and processing the layer, the substrate remains heated to a temperature of at least 500° C. It is also possible with the construction cylinder arrangements according to the invention to ensure a gas-tight sealing of the construction cylinder arrangements and therefore of the process chamber during the laser processing at a high processing temperature.

Additional advantages of the invention will be appreciated from the description and the drawings. The features mentioned above and those set out below can also be used individually per se or together in any combination. The embodiments shown and described are not intended to be understood to be a conclusive listing, but instead are of an exemplary nature for describing the invention.

The invention is illustrated in the drawings and is explained in greater detail with reference to embodiments.

### DESCRIPTION OF DRAWINGS

FIG. 1 is a schematic oblique cross-section of the upper end region of an embodiment of a construction cylinder arrangement according to the invention with a base member and piston.

FIG. 2 is a schematic oblique cross-section of the piston of FIG. 1 illustrated with a translucent substrate.

FIG. 3A is a schematic oblique view of a clamping device of the piston of FIG. 1, with a locking bar in a first rotational position (lift-off position).

FIG. 3B is a schematic oblique view of the clamping device of FIG. 3A, with the locking bar in a second rotational position (locking position).

FIG. 4 is a schematic oblique cross-section of the lower end region of an embodiment of a construction cylinder arrangement according to the invention, wherein only an upper portion of the piston is retained in the base member.

FIG. 5 is a schematic partial cross-section of another embodiment of a construction cylinder arrangement according to the invention, with a differential screw as a positioning element.

FIG. 6 is a schematic oblique cross-section of a glycerine expansion element of a construction cylinder arrangement according to the invention.

FIG. 7 is a schematic side view of a machine according to the invention for producing three-dimensional objects in layers.

FIG. 8A is a schematic plan view of a substrate in a machine according to the invention during a triangulation measurement.

FIG. 8B is a side view of the substrate and the machine of FIG. 8a.

FIG. 9 is a schematic partial cross-section of a piston for the invention with a flexible metal spring as the contact element.

### DETAILED DESCRIPTION

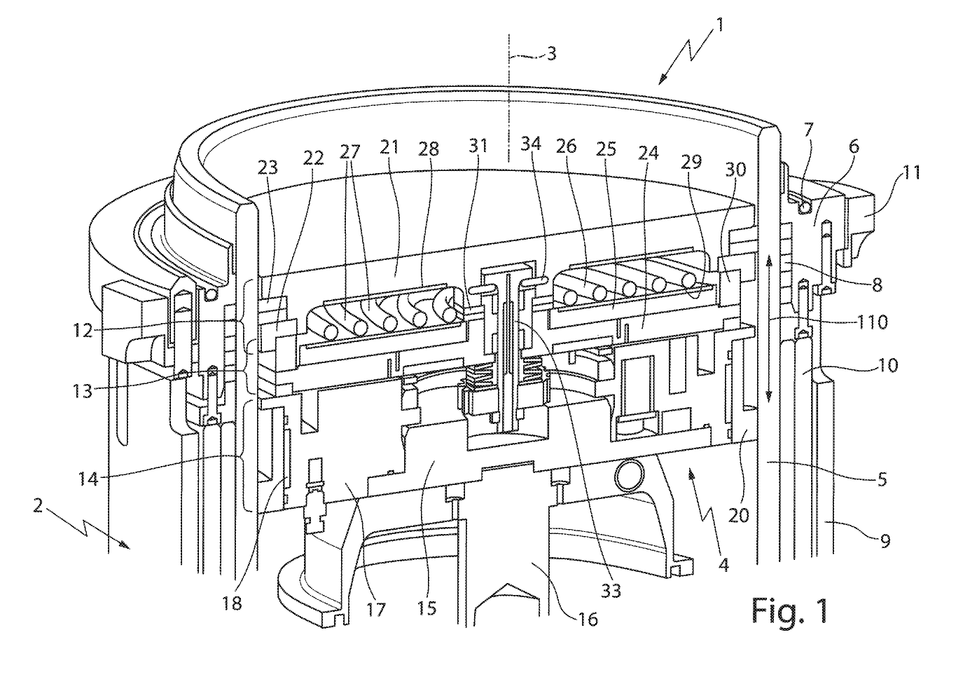

FIG. 1 shows the upper end region of an embodiment of a construction cylinder arrangement 1 according to the invention comprising a substantially cylinder-tube-like base member 2 and a piston 4 that can be displaced in the base member along a cylinder axis 3.

The base member 2 is constructed on the inner side with a cylinder-tube-like insulation member 5, e.g., made of an opaque quartz glass. The quartz glass can have a thermal conductivity of approximately 2 W/(m*K).

The insulation member 5 is retained by a clamping ring 6, which is constructed with a cooling water channel 7 and which clamps the insulation member 5 via a stuffing box 8 comprising a ceramic woven fabric (for example, Al₂O₃ woven fabric). The insulation member 5 is further surrounded by a cylinder-tube-like outer member 9, e.g., constructed from steel. A thermal insulation structure 10, in this instance comprising ceramic fiber mats, is arranged between the outer member 9 and the insulation member 5.

The base member 2 is further provided with hook elements 11 with which the base member 2 can easily be hung (and removed again) in a machine for producing three-dimensional objects.

The piston 4 is constructed here with an upper portion 12, a central portion 13, and a lower portion 14.

The lower portion 14 substantially comprises a base 15, on which a lifting device 16 engages, and a cooling plate 17, in which an annular channel for cooling water is constructed as a cooling device 18. A first seal 20 of elastomer material, which forms a gas-tight closure between the cooling plate 17 and the insulation member 5, is arranged on the cooling plate 17. If desired, the first seal 20 can also be constructed as a hydraulic or pneumatic seal, wherein a gas or a hydraulic fluid is guided in a hollow space of the first seal of elastomer material (not illustrated). The radial extent or the application force of the first seal can then be adjusted via the pressure in the hollow space.

The upper portion 12 substantially comprises a substrate 21, on which a three-dimensional object (not illustrated) can be constructed in layers at the upper side, in addition a clamping ring 22, which is positioned radially on the substrate 21, and a second seal 23, in this instance made of a ceramic woven fabric material, for example, Al₂O₃ woven fabric material (alternatively a metal fiber seal can also be used). The second seal 23 is axially clamped here between the substrate 21 and the clamping ring 22 and radially presses outwards against the insulation member 5 so that powdered material (not illustrated) that is used to grow the three-dimensional object on the substrate 21 is retained.

The central portion 13 substantially comprises a metal base plate 24, a ceramic insulation plate 25 arranged thereon, and a heating device 26, in this case constructed so as to have a plurality of infrared heating coils 27.

The heating device 26 is axially arranged between the substrate 21 and the ceramic insulation plate 25. The lower side of the substrate 21 is provided in this case with an infrared absorption layer 28 of black chrome, with which approximately 90% of the striking infrared radiation of the heating coils 27 can be absorbed. However, the upper side of the insulation plate 25 is provided in this case with an infrared reflection layer 29, in this case a reflective metal layer, which reflects approximately 90% of the striking infrared radiation. It is thereby ensured that the main portion of the heating power of the heating device 26 heats the substrate 21, wherein typically temperatures between 500° C. and 1000° C. can be reached and only a small portion of the heating power is introduced into the lower portion 14 of the piston 4.

An axial spacing 110 of approximately 5 cm here is located between the contact regions with respect to the insulation member 5 of the first seal 20 and of the second seal 23 for thermal insulation; generally, an axial spacing 110 of 3 cm or more, preferably 5 cm or more, is produced. The axial spacing 110 together with the poorly thermally conductive material of the insulation member limits the heating of the first seal 20 via the insulation member 5, which allows the use of elastomer material at the first seal.

The upper portion 12 of the piston 4 is positioned on the central portion 13 via ceramic components, e.g., a ceramic ring 30 and ceramic discs 31, which further improve the thermal insulation of the upper portion 12.

In this case, the upper portion 12 is supported in a rotationally secure manner with respect to the cylinder axis 3, for example, by means of an indexing pin (not illustrated). During production operation for the three-dimensional object, the upper portion 12 is clamped with the central portion 13 and, for changing the construction cylinder arrangement 1 in the machine, the upper portion 12 can be lifted off the central portion 13, for which a rotationally actuated clamping device can be used.

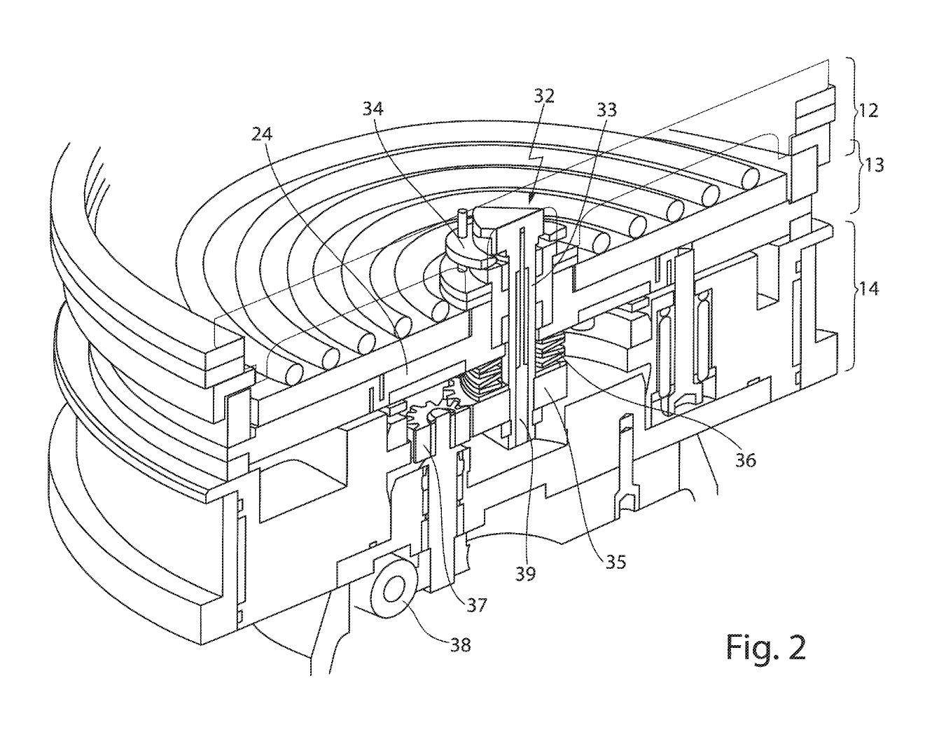

This clamping device 32 is initially explained in greater detail with reference to FIG. 2. The clamping device 32 is based on the cooperation of a locking bar 33, which is rotatable and axially displaceable on the metal base plate 24, and a retention member 34, which is constructed or arranged on the lower side of the substrate (not illustrated in FIG. 2 for greater clarity). The locking bar 33 (in which a temperature sensor 39 is also arranged here) is fixed at the bottom end to a guide element 35 in a rotationally secure manner, wherein the guide element 35 can be in the form of a sprocket or gear with teeth and can be rotated via a gear mechanism 37. The teeth are constructed so as to be straight so that the guide component 35 can be displaced axially relative to the gear mechanism 37, wherein a mutual engagement always remains. The gear mechanism 37 can be actuated here from below the lower portion 14 with an electric motor 38. The guide element 35, and therefore also the locking bar 33, is further pre-tensioned by means of a resilient element 36, in this case a pressure spring, into a downwardly drawn position. The resilient element 36 is supported at the upper end on the metal base plate 24, that is to say, on the central portion 13.

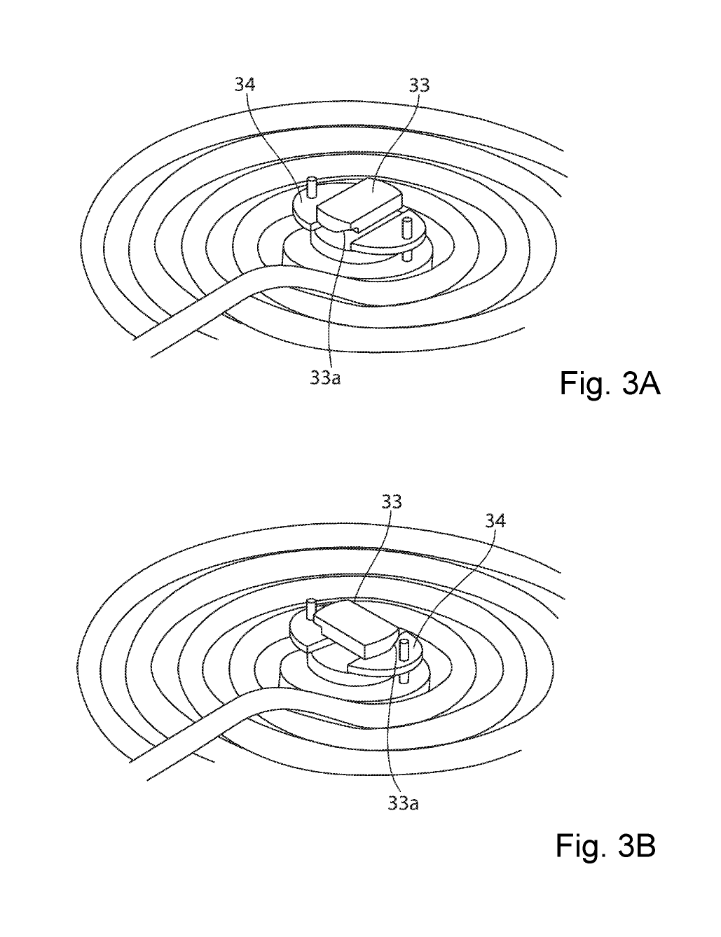

In a first rotational position of the locking bar 33, illustrated in FIG. 3A, the locking bar 33 with the upper end thereof (locking bar head) is out of engagement with the retention member 34, which here comprises two mutually opposed and spaced apart half-discs. In this rotational position, the upper portion 12 including the retention member 34 can be lifted off the remaining piston portions, that is to say, the central portion 13 and the lower portion 14.

In a second rotational position of the locking bar 33, illustrated in FIG. 3B, the locking bar 33 engages with the upper end thereof behind the retention member 34. In this case, the locking bar 33 is slid onto the retention member 34 as a result of an inclined face 33a and has gradually pressed the retention member downwards during the rotational movement (relative to the locking bar head).

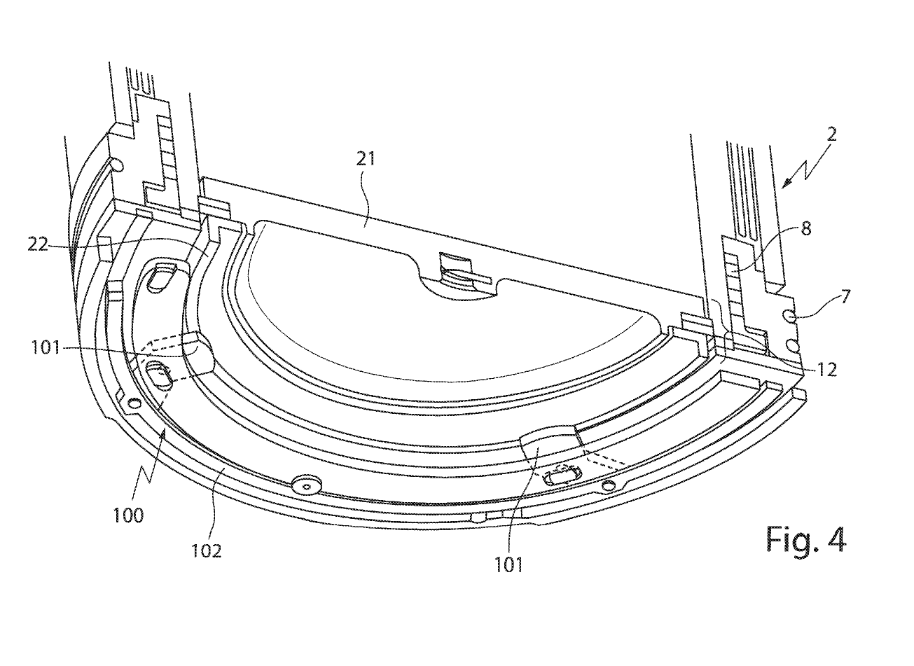

The separation of the piston in the first rotational position of the locking bar is typically carried out after a three-dimensional object has been finished on the substrate 21 when the piston has arrived in a position moved axially downwards in the base member 2 and the upper portion 12 is still hot, cf. in this regard FIG. 4. The central and lower portion of the piston is intended to be quickly available for the production of an additional three-dimensional object, whereas the (internally) still-hot base member 2 and the even hotter upper portion 12 are intended to cool away from the machine, for which the upper portion 12 is intended to remain in the base member 2.

A locking bar system 100 having a plurality of locking bar webs 101, which can commonly be radially pivoted in and out via an annular actuator 102, is provided at the lower end of the base member 2. At a suitable axial displacement position of the piston the locking bar webs 101 can pivot in under the clamping ring 22 of the upper portion 12 (or between the upper portion 12 and the lower portion of the piston), and thus engage under the clamping ring 22. The upper portion 12 can then be lifted off the central portion (at the first rotational position of the locking bar), which in practice is generally carried out by lowering the central and lower portion of the piston.

In the situation shown in FIG. 4, the locking bar system 100 retains the upper portion 12 of the piston in the base member 2 with the locking bar webs 101 pivoted in under the clamping ring 22.

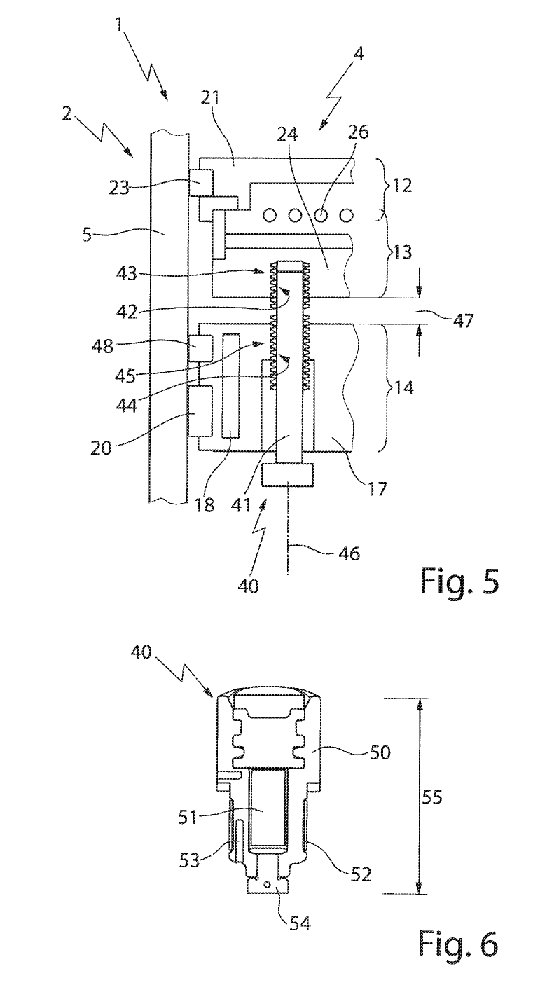

FIG. 5 represents a portion of an additional embodiment of a construction cylinder arrangement 1 according to the invention, wherein only the insulation member 5 of the base member 2 and only a left-side portion of the piston 4 are illustrated. In this embodiment, the central portion 13 of the piston 4 is supported via three positioning elements 40 on the lower portion 14 of the piston 4; in FIG. 5, only one of the positioning elements 40 can be seen in section.

The positioning element 40 is constructed here as a differential screw 41 that is guided with a first thread portion 42 of a first pitch (small in this case) into a counter-thread 43 on the central portion 13 and is guided with a second thread portion 44 of a second pitch (large in this case) in a counter-thread 45 on the lower portion 14. By the differential screw 41 being turned about the screw axis 46 thereof, for example, manually with an Allen key or automatically with an electric motor (not illustrated), the spacing 47 between the metal base plate 24 of the central portion 13 and the cooling plate 17 of the lower portion 14 can be adjusted in the region of the differential screw 41.

By the total of three positioning elements 40, which can be arranged in a manner distributed uniformly around the cylinder axis of the construction cylinder arrangement 1 being adjusted, the tilting position of the substrate 21 relative to the base member 2 and relative to the entire machine, in which the three-dimensional object is produced, can be aligned.

In the embodiment shown, not only is a first seal 20 of elastomer material, for example, of vulcanized natural rubber, provided on the cooling plate 17, but also a stuffing or packing material 48 made of a woven fabric or felt of graphite fibers (or another heat-resistant and highly thermally conductive material) as a flexible contact element. This stuffing or packing material 48 transmits cooling power of the cooling device 18, here a cooling water channel, from the cooling plate 17 to the insulation member 5 above the first seal 20. The introduction of heat into the first seal 20 is thereby reduced. A large portion of the heat introduced into the insulation member 5 by the heating device 26 (in particular via the substrate 21 and the second seal 23) is removed from the insulation member 5, again by the stuffing or packing material 48 (which abuts the insulation member 5 at the inner side between a first seal 20 and a second seal 23) before it can impair or damage the first seal 20 or the elastomer material thereof.

FIG. 6 shows a positioning element 40 for a construction cylinder arrangement 1 according to the invention, which is constructed as an expansion element 50, here as a glycerine expansion element. An expansion fluid, for example, glycerine, is arranged in an expansion chamber 51. A heating element 52, e.g., a resistance heating unit comprising a winding of copper wire, is arranged radially around the expansion chamber 51. A thermal element (not illustrated, for example, a thermal sensor such as the PT100 type, which has a resistance of 100 Ohm at 0° C.) is arranged in a measurement recess 53 near the expansion chamber 51 to control the temperature of the expansion fluid in the expansion chamber 51. Depending on the temperature thereof, a stamp 54, which abuts the expansion chamber 51 at the end side, is axially pressed to a greater or lesser extent by the expansion fluid axially out of the expansion element 50. The length 55 of the expansion element 50 can thereby be changed. The length 55 of the expansion element 50 can easily be controlled via the electric current at the resistance heating unit. Typically, the central portion or upper portion of a piston is lying on the stamp 54 and the remaining expansion element 50 is retained in the lower portion. The contact with the piston can be brought about via ceramic discs.

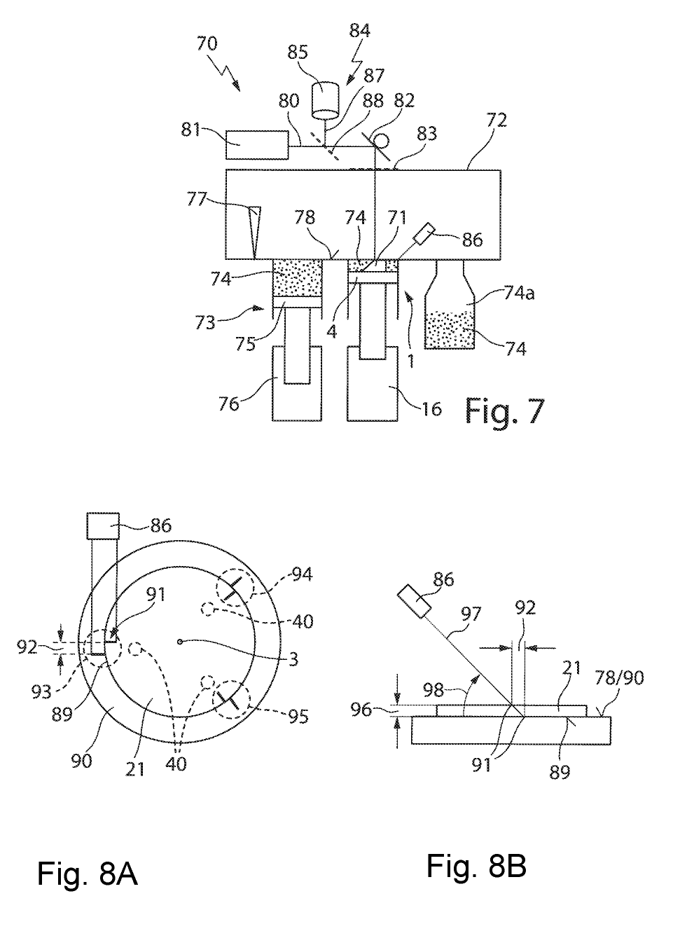

FIG. 7 is a schematic side view of an embodiment of a machine 70 according to the invention for producing a three-dimensional object 71 (or a plurality of three-dimensional objects) in layers. The machine 70 comprises a gas-tight process chamber 72 that can be filled and/or purged in a manner not shown in greater detail with an inert gas, for example, nitrogen or a noble gas, such as argon.

A storage cylinder arrangement 73 for a powdered material 74 (illustrated with dots) from which the three-dimensional object 71 is produced by laser sintering or laser melting is connected to the process chamber 72. The powdered material 74 may consist of, for example, metal particles with a mean particle size (D50) of 25 to 100 μm. A small quantity of the powdered material 74 is lifted above the level of the bottom 78 of the process chamber 72 by incrementally moving up a powder piston 75 with a powder lifting device 76 so that this small quantity can be conveyed with a slide 77 which can be actuated in a motorized manner to a construction cylinder arrangement 1 according to the invention (for example, constructed as illustrated in FIG. 1).

The construction cylinder arrangement 1, which is also connected to the process chamber 72, includes the piston 4, on which the three-dimensional object 71 is produced at the upper side (on the substrate, not illustrated in greater detail). Before the production of a new layer of the three-dimensional object 71, the piston 4 is lowered with a lifting device 16 by a step and a small quantity of the powdered material 74 is swept with the slide 77 into the construction cylinder arrangement 1.

The freshly applied powder layer is subsequently locally illuminated, and thereby locally powerfully heated, from above with a processing laser beam 80 (here, being introduced from a local processing laser 81 and through a window 83 into the process chamber 72) at positions which are designated for a local compaction (melting, sintering) of the powdered material 74. In this case, the processing laser beam 80 is guided (scanned) by an optical scanner unit 82 (in particular containing one or more mirrors that can be pivoted in total about at least two axes) over the substrate.

Subsequently, additional layers are produced until the three-dimensional object is completed. Excess powdered material 74 can be swept into a collection container 74a with the slide 77.

After the three-dimensional object 71 is completed, the construction cylinder arrangement 1 can (preferably after the access opening of the process chamber 72 with respect to the construction cylinder arrangement 1 has been closed from the process chamber 72 to maintain the inert gas atmosphere in the process chamber 72) be decoupled (for example, unhooked) and removed, and can be replaced by a new construction cylinder arrangement. Typically, a central and lower portion of the piston 4 remains on the machine 1 or on the lifting device 76 and is also used with the new construction cylinder arrangement (that is to say, only the base member and the upper portion of the piston of the construction cylinder arrangement 1 are exchanged). Thereby the machine 1 can be operated again quickly.

Before the beginning of a laser processing operation of the powdered material 74 on the substrate, the powdered material 74 should be heated to increase the processing quality. In this case, there may result a thermal deformation, in particular tilting, of the substrate in the construction cylinder arrangement 1. To be able to detect such a deformation, the machine 70 includes a measuring device 84 that substantially comprises in this case a camera 85 and three laser diodes 86 for producing a laser line, respectively (in FIG. 7, only one laser diode 86 is illustrated for the sake of simplicity). In this case, the beam path 87 of the camera 85 is guided, using a semi-transparent mirror 88, partially parallel with the beam path of the processing laser beam 80 (wherein the processing laser beam 80 is then switched off) so that the optical scanner unit 82 can also be used with the beam path 87 of the camera 85. By switching the scanning position of the optical scanner unit 82, different positions, which are illuminated by the laser diodes 86, can then be selectively selected and detected with the camera with high resolution.

In FIG. 8A, the measurement principle applied is explained in greater detail by way of example as a plan view of the substrate 21. The laser diode 86 directs a laser line 91 towards a gap 89 between the substrate 21 and a reference surface 90 of the process chamber, for example, the bottom of the process chamber. The laser line 91 preferably extends approximately perpendicularly to the local gap 89. In the case of a height offset between the substrate 21 and the reference surface 90, the (projected) laser line 91 has a line offset 92 when viewed from above and approximately parallel with the local direction of the gap 89. This line offset 92 can readily be detected by the camera, if it is directed towards the position 93 by means of the optical scanner unit, with an automatic image identification system and can be processed electronically, in particular for automatic positioning element control.

By means of additional laser diodes (not illustrated), a line offset is also determined in the same manner at the positions 94, 95; the positions 93, 94, 95 on the gap 89 are uniformly distributed about the cylinder axis 3 (that is to say, at an angular offset of approximately 120°). The inclination of the substrate 21 in total can thereby be detected, and a levelling of the substrate 21 (that is to say, a planar alignment of the substrate 21, relative to the remaining machine or process chamber) can be achieved by simultaneous minimization of all the line offsets 92.

In the construction type shown, one positioning element 40 is provided in the piston under the substrate 21, at the angular positions which correspond to the measured positions 93, 94, 95 in each case so that the control of a positioning element 40 can directly be carried out via the line offset 92 of the associated measured position 93, 94, 95, respectively.

FIG. 8B again illustrates the geometry during the triangulation measurement in the context of the invention as a side view. The line type measuring laser beam 97 from the laser diode 86 strikes the gap 89 at an acute angle 98, e.g., of approximately 45° in this case. A first portion of the projected laser line 91 is located at the upper side of the substrate 21 and a second portion of the projected laser line 91 is located on the surface of the reference surface 90 with a (horizontal) line offset 92. The height offset 96 between the upper side of the substrate 21 and the upper side of the reference surface 90 can easily be determined from the line offset 92 and the angle 98 using the following equation:

Height offset (96)/Line offset (92)=tan(angle (98))

With a negligible line offset 92, the height offset 96 also becomes negligible. If the height offset 96 disappears at all three measured positions, the substrate 21 is levelled.

It should be noted that in place of a negligible height offset 96, a height offset that is identical at all the measured positions can also be produced in order to level the substrate 21.

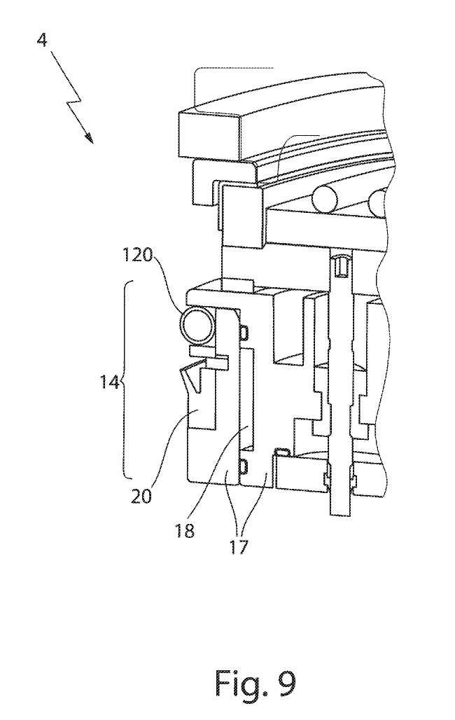

FIG. 9 is a partial cross-section of a piston 4 of the invention. In this instance, a peripheral flexible metal spring 120, with which cooling power can be transmitted from the cooling device 18 (in this instance, a cooling water channel) through the cooling plate 17 radially outwards into the insulation member (not illustrated), is arranged on the lower portion 14 above the first seal 20 as a flexible contact element to reduce the temperature of the insulation member in the region of the adjacent first seal 20. The flexible metal spring 120 is easy to install, cost-effective and wear-resistant.

### LIST OF REFERENCE NUMERALS

1 Construction cylinder arrangement
2 Base member
3 Cylinder axis
4 Piston
5 Insulation member
6 Clamping ring
7 Cooling water channel
8 Stuffing box
9 Outer member
10 Insulation structure
11 Hook elements
12 Upper portion
13 Central portion
14 Lower portion
15 Base
16 Lifting device
17 Cooling plate
18 Cooling device
20 First seal
21 Substrate (construction platform)
22 Clamping ring
23 Second seal
24 Base plate
25 Ceramic insulation plate
26 Heating device
27 Heating coil
28 Infrared absorption layer
29 Infrared reflection layer
30 Ceramic ring
31 Ceramic discs
32 Clamping device
33 Locking bar
33a Inclined surface
34 Retention member
35 Guide element
36 Resilient element
37 Gear mechanism
38 Electric motor
39 Temperature sensor
40 Positioning element
41 Differential screw
42 First thread portion
43 Counter-thread
44 Second thread portion
45 Counter-thread
46 Screw axis
47 Spacing
48 Packing material
50 Expansion element
51 Expansion chamber
52 Heating element
53 Measurement recess
54 Stamp
55 Length
70 Machine
71 Three-dimensional object
72 Process chamber
73 Storage cylinder arrangement
74 Powdered material
74a Collection container
75 Powder piston
76 Powder lifting device
77 Slide
78 Bottom
80 Processing laser beam
81 Processing laser
82 Optical scanner unit (laser scanner)
83 Window
84 Measuring device
85 Camera
86 Laser diode
87 Beam path of camera
88 Semi-permeable mirror
89 Gap
90 Reference surface
91 Laser line
92 Line offset
93 Position
94 Position
95 Position
96 Height offset
97 Measuring laser beam
98 Angle
100 Locking bar system
101 Locking bar webs
102 Annular actuator
110 Axial spacing
120 Flexible metal spring

### OTHER EMBODIMENTS

A number of embodiments of the invention have been described. Nevertheless, it will be understood that various modifications may be made without departing from the spirit and scope of the invention. Accordingly, other embodiments are within the scope of the following claims.

What is claimed is:

1. A construction cylinder arrangement for a machine for producing three-dimensional objects in layers by laser sintering or laser melting powdered material, comprising:
a substantially cylinder-jacket-like base member having a cylinder axis and comprising a substantially cylinder-jacket-like insulation member that forms at least an inner side of the base member, wherein the insulation member comprises a material having a specific thermal conductivity λIK≤3 W/(m*K); and
a piston that can be displaced along the cylinder axis along the inner side of the base member, wherein the piston has at an upper side thereof a substrate for growing the three-dimensional objects;
wherein the piston is constructed with an upper piston portion and a lower piston portion, wherein the upper piston portion comprises the substrate, and wherein the lower piston portion comprises a cooling device, and a first seal of elastomeric material with which the lower piston portion is sealed in a gas-tight manner with respect to the inner side of the base member.

2. The construction cylinder arrangement of claim 1, wherein the cooling device comprises a cooling water channel system.

3. The construction cylinder arrangement of claim 1, wherein the insulation member comprises a ceramic material or a glass material.

4. The construction cylinder arrangement of claim 3, wherein the insulation member comprises a quartz glass material.

5. The construction cylinder arrangement of claim 3, wherein the insulation member comprises a ceramic material.

6. The construction cylinder arrangement of claim 1, wherein ceramic insulation components are arranged in the piston between the upper portion and the lower portion.

7. The construction cylinder arrangement of claim 6, wherein the ceramic insulation components comprise one or more of a ceramic insulation plate, a ceramic ring, and a ceramic disc.

8. The construction cylinder arrangement of claim 1, wherein the first seal is constructed as a hydraulic or pneumatic seal, the outer diameter of which can be adjusted by a pressure of hydraulic fluid or gas.

9. The construction cylinder arrangement of claim 1, wherein the piston comprises a heating device arranged to heat the substrate, wherein the heating device is arranged below the substrate and above the lower portion of the piston, which has the cooling device.

10. The construction cylinder arrangement of claim 9, wherein the heating device is arranged to heat the substrate to a temperature of 500° C. or more.

11. The construction cylinder arrangement of claim 9, wherein the heating device comprises one or more infrared heating elements, wherein an infrared absorption layer having an infrared absorption capacity of 0.8 or more is provided above the one or more heating elements, and wherein an infrared reflection layer having an infrared reflection capacity of 0.8 or more is provided under the one or more infrared heating elements.

12. The construction cylinder arrangement of claim 11, wherein the one or more infrared heating elements comprise heating coils, the infrared absorption layer comprises black chrome or titanium aluminum nitride, and the infrared reflection layer comprises a reflective metal layer or a reflective ceramic layer.

13. The construction cylinder arrangement of claim 11, wherein the infrared absorption layer is constructed or arranged on a lower side of the substrate, and the infrared reflection layer is constructed or arranged on an upper side of a ceramic insulation plate.

14. The construction cylinder arrangement of claim 1, further comprising a flexible contact element arranged on the lower piston portion above the first seal to abut the inner side of the insulation member.

15. The construction cylinder arrangement of claim 14, wherein the flexible contact element comprises (i) a packing material comprising a woven graphite fabric or graphite felt or (ii) a flexible metal spring.

16. The construction cylinder arrangement of claim 1, wherein the piston comprises at least two positioning elements with which the upper piston portion can be aligned relative to the lower piston portion to level the substrate.

17. The construction cylinder arrangement of claim 16, wherein the piston further comprises a central piston portion, wherein the upper piston portion is supported on the central piston portion and the central piston portion can be aligned relative to the lower piston portion by the positioning elements.

18. The construction cylinder arrangement of claim 16, wherein the positioning elements each comprise an expansion element, whose length is variable as a result of the temperature, and an electrical heating element, with which the expansion element can be heated so that a local spacing of the upper piston portion relative to the lower piston portion or central piston portion at the respective positioning element can be adjusted by adjusting the temperature of the expansion element via the electrical heating element and by impact of the cooling device.

19. The construction cylinder arrangement of claim 18, wherein the expansion element comprises a metal piece made of a shape memory alloy or a glycerine expansion element.

20. The construction cylinder arrangement of claim 16, wherein the positioning elements each comprise a differential screw guided with a first thread portion of a first pitch in a counter-thread in the upper piston portion or in a central piston portion of and with a second thread portion of a second pitch in a counter-thread in the lower piston portion.

21. The construction cylinder arrangement of claim 1, wherein the upper piston portion is releasably supported on the remaining piston.

22. The construction cylinder arrangement of claim 17, wherein the upper piston portion is releasably supported on the remaining piston, wherein the upper piston portion is supported in a rotationally secure manner on the central piston portion so as to be lying thereon, and wherein the upper piston portion can be axially clamped by a rotationally actuated clamping device arranged on the central piston portion.

23. The construction cylinder arrangement of claim 22, wherein the rotationally actuated clamping device comprises a locking bar and a retention member, wherein the locking bar is rotatably supported in the central piston portion, wherein in a first rotational position the locking bar can be introduced and withdrawn into/out of the retention member at the lower side of the substrate, wherein the locking bar engages behind the retention member in a second rotational position, and wherein one or more inclined faces are constructed on the locking bar and/or the retention member so that, by rotating the locking bar in the retention member from a first position into a second position, the substrate is pressed downwards relative to the locking bar.

24. The construction cylinder arrangement of claim 23, further comprising a guide element fixed to the locking bar, wherein the guide element is supported or suspended on the central piston portion or lower piston portion via a resilient element, and wherein the resilient element pretensions the locking bar via the guide element into a position drawn axially downwards.

25. The construction cylinder arrangement of claim 22, wherein the clamping device comprises a cylindrical or conical first threaded element supported on the central piston portion, and a conical second threaded element constructed on the lower side of the substrate, wherein the threaded elements can be screwed together to clamp the central piston portion and the upper piston portion.

26. The construction cylinder arrangement of claim 1, further comprising a second seal arranged on the upper piston portion to seal the upper piston portion relative to the inner side of the base member at least in a sealing manner with respect to the powdered material.

27. The construction cylinder arrangement of claim 26, wherein the second seal is constructed as a metal fiber seal made of metal fibers that are pressed together, wherein the pressed metal fibers are arranged between the piston and the inner side of the base member with resilient compressive strain.

28. The construction cylinder arrangement of claim 26, wherein the upper piston portion further comprises a clamping ring and the second seal comprises felt or woven material, wherein the clamping ring and the substrate are securely connected to each other, and wherein the second seal is clamped between the substrate and the clamping ring.

29. The construction cylinder arrangement of claim 21, further comprising constructed on the base member a radially extensible and retractable locking bar system with which the upper piston portion can be engaged under in a displacement position of the piston at the lower end of the base member so that, when the upper piston portion is released from the remaining piston portion or portions, the upper piston portion is retained in the base member.

30. The construction cylinder arrangement of claim 1, wherein the base member further comprises a cylinder-jacket-like outer member, the insulation member is clamped in the outer member by at least one stuffing box, and wherein a thermal insulation structure is arranged at least over a portion of the axial extent of the base member between the outer member and the insulation member.

31. The construction cylinder arrangement of claim 30, wherein the cylinder-jacket-like outer member comprises metal, the stuffing box comprises a ceramic woven fabric or felt, and the thermal insulation structure comprises a ceramic material.

32. A machine for producing three-dimensional objects in layers by laser sintering or laser melting powdered material, the machine comprising
a process chamber;
a storage cylinder arrangement for the powdered material connected to the process chamber;
a construction cylinder arrangement of claim 1 connected to the process chamber and including a substrate upon which three-dimensional objects are produced;
a slide arranged in the process chamber for applying a layer of the powdered material from the storage cylinder arrangement to the substrate of the construction cylinder arrangement;
a processing laser for producing a processing laser beam or a coupling device for a processing laser beam; and
an optical scanner unit for scanning the processing laser beam over the substrate.

33. A method for operating a machine of claim 32, the method comprising
applying a layer of powdered material to the substrate;
heating at least a layer of the powdered material to a temperature of at least 500° C. during and/or after applying the layer; and
processing the heated layer with a laser beam while air is excluded,
wherein during a plurality of cycles of lowering the piston in the base member by a layer thickness, applying a layer of powdered material, and heating and processing the layer, the substrate remains heated to a temperature of at least 500° C.
